(19) United States
(12) Patent Application Publication
(10) Pub. No.: US 2011/0316805 A1
(43) Pub. Date: Dec. 29, 2011

(54) ELECTRONIC DEVICE

(76) Inventor: Youji YAMADA, Yokohama (JP)

(21) Appl. No.: 13/171,012

(22) Filed: Jun. 28, 2011

(30) Foreign Application Priority Data
Jun. 28, 2010 (JP) 2010-146972
Jun. 28, 2010 (JP) 2010-146973
Jul. 28, 2010 (JP) 2010-169885

(51) Int. Cl. G06F 3/041

(52) U.S. Cl. 345/173

(57) ABSTRACT

An electronic device is disclosed. A displacement detection module comprises a detection surface that is disposed in a housing and operable to detect a displacement of a substance that is brought into contact with the detection surface. A detection module is operable to detect an instantaneous value of the displacement, and detect an integrated value of the displacement. A signal generation module is operable to generate a control signal based on the instantaneous value and the integrated value, and a control module is operable to perform a predefined function in response to the control signal.

### CROSS-REFERENCE TO RELATED APPLICATION

The present application claims priority under 35 U.S.C. §119 to Japanese Patent Application No. 2010-146972, filed on Jun. 28, 2010, entitled “ELECTRONIC DEVICE”, Japanese Patent Application No. 2010-146973, filed on Jun. 28, 2010, entitled “ELECTRONIC DEVICE” and Japanese Patent Application No. 2010-169885, filed on Jul. 28, 2010, entitled “ELECTRONIC DEVICE”. The content of which is incorporated by reference herein in its entirety.

### FIELD

Embodiments of the present disclosure relate generally to electronic devices comprising an input module.

### BACKGROUND

Electronic devices may comprise mobile phones, PDAs, portable navigation devices, mobile electronic devices such as mobile game machines, personal computers (PC) and the like. Electronic devices comprise an operation module for inputting operations. The operation module may comprise a keyboard, a touch panel, a mouse and the like. Pointing devices such as cursors, pointers or icons, which perform operations that may comprise a mouse, a lever, a direction key for inputting directions such us upward, downward, leftward, and rightward, and devices that detect changes in the contact with the contact surface (surface) (movement of the ridges of fingers).

When optical sensors are used, there are advantages in that changes in the contact with the contact surface are detected and in that the operation module, such as the cursor, pointer or icon that performs the operations can reduce a size of the configuration.

For cases in which a cursor is moved with respect to a list on which multiple items are displayed using the pointing devices, when the cursor is moved with files having sentences and images to be displayed that are large with respect to the display area of the screen, in order to move the cursor and the pointer a long distance, it is necessary to input the operation repeatedly in a same direction. Therefore, with devices that detect the operations in response to changes in contact with the contact surface, it is necessary to continue changing the contact with the contact surface. For example, it is necessary to continue moving the position of the cursor by continuously moving the finger. Therefore, the operation becomes complex and it takes time to display a desired screen.

### SUMMARY

An electronic device is disclosed. A displacement detection module comprises a detection surface that is disposed in a housing and is operable to detect a displacement of a substance that is brought into contact with the detection surface. A detection module is operable to detect an instantaneous value of the displacement, and detect an integrated value of the displacement. A signal generation module is operable to generate a control signal based on the instantaneous value and the integrated value, and a control module is operable to perform a predefined function in response to the control signal. In this manner, electronic devices that can input necessary operations by simple or quick operations are provided.

In an embodiment, an electronic device comprises a housing, a displacement detection module, a detection module, a signal generation module, and a control module. The displacement detection module comprises a detection surface that is disposed in the housing, and is operable to detect a displacement of a substance that is brought into contact with the detection surface. The detection module is operable to detect an instantaneous value of the displacement, and detect an integrated value of the displacement. The signal generation module is operable to generate a control signal based on the instantaneous value and the integrated value. The control module is operable to perform a predefined function in response to the control signal.

In another embodiment, an electronic device comprises a housing, a display module on the housing, a displacement detection module, a parameter detection module, and a control module. The displacement detection module comprises a detection surface that is disposed in the housing and operable to detect a substance displacement of a substance that is brought into contact with the detection surface. The parameter detection module is operable to detect an instantaneous value of the substance displacement that is detected in the displacement detection module, and to detect a time interval in which the displacement is measured in the displacement detection module. The control module is operable to generate a control signal based on the instantaneous value and the time interval if the instantaneous value exceeds a displacement threshold of the displacement. The control module is further operable to control the predefined function based on the control signal, and change the threshold of the displacement based on the time interval.

### BRIEF DESCRIPTION OF THE DRAWINGS

Embodiments of the present disclosure are hereinafter described in conjunction with the following figures, wherein like numerals denote like elements. The figures are provided for illustration and depict exemplary embodiments of the present disclosure. The figures are provided to facilitate understanding of the present disclosure without limiting the breadth, scope, scale, or applicability of the present disclosure. The drawings are not necessarily made to scale.

FIG. 1 is a front view showing the external appearance of a mobile phone terminal 1, used as a character input device according to an embodiment of the present disclosure.

FIG. 2 shows a virtual keyboard that is displayed on the touch panel according to an embodiment of the present disclosure.

FIG. 3 is a cross-sectional diagram showing the schematic configuration of a input device according to an embodiment of the present disclosure.

FIG. 4 is a surface diagram showing a schematic configuration of a input device according to an embodiment of the present disclosure.

FIG. 5 is a diagram showing one example of input actions according to an embodiment of the present disclosure.

FIG. 6 is an illustration of a schematic functional block diagram of a mobile phone terminal according to an embodiment of the present disclosure.

FIG. 7 is a diagram showing an action of the input device according to an embodiment of the present disclosure.

FIG. 8 is a graph showing a relationship between a detected instantaneous value and an integrated value vs. time according to an embodiment of the present disclosure.

FIG. 9 is a graph showing relationships between instantaneous value and the integrated value vs. time, when an input device detects an operation according to an embodiment of the present disclosure.

FIG. 10 is a graph showing relationships between instantaneous value and the integrated value vs. time, when an input device detects an operation according to an embodiment of the present disclosure.

FIG. 11 is an exemplary flow diagram showing actions of a mobile phone terminal according to an embodiment of the present disclosure.

FIGS. 12A-12C are exemplary diagrams showing actions of a mobile phone terminal according to an embodiment of the present disclosure.

FIG. 13 is a schematic functional block diagram of a mobile phone terminal according to an embodiment of the present disclosure.

FIG. 14 is a graph showing a relationship between a threshold of a displacement amount and an elapsed time according to an embodiment of the present disclosure.

FIG. 15 is an illustration of an exemplary flow diagram of a mobile phone terminal according to an embodiment of the present disclosure.

FIG. 16 is an illustration of an exemplary flow diagram of a mobile phone terminal according to an embodiment of the present disclosure.

FIG. 17 is an illustration of an exemplary flow diagram of a mobile phone terminal according to an embodiment of the present disclosure.

FIGS. 18A-18C are exemplary diagrams showing actions of a mobile phone terminal according to an embodiment of the present disclosure.

FIG. 19 is an illustration of an exemplary diagram showing an action of an input device according to an embodiment of the present disclosure.

FIG. 20 is an illustration of an exemplary flow diagram showing actions of a mobile phone terminal according to an embodiment of the present disclosure.

FIGS. 21A-21C are exemplary diagrams showing actions of a mobile phone terminal according to an embodiment of the present disclosure.

FIG. 22 is a schematic front view of a mobile phone terminal according to an embodiment of the present disclosure.

FIG. 23 is a side view of the mobile phone terminal shown in FIG. 22 according to an embodiment of the present disclosure.

### DETAILED DESCRIPTION

The following description is presented to enable a person of ordinary skill in the art to make and use the embodiments of the disclosure. The following detailed description is exemplary in nature and is not intended to limit the disclosure or the application and uses of the embodiments of the disclosure. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the disclosure. The present disclosure should be accorded scope consistent with the claims, and not limited to the examples described and shown herein.

Embodiments of the disclosure are described herein in the context of one practical non-limiting application, namely, an information-processing device such as a mobile phone. Embodiments of the disclosure, however, are not limited to such mobile phone, and the techniques described herein may be utilized in other applications. For example, embodiments may be applicable to digital books, digital cameras, electronic game machines, digital music players, personal digital assistance (PDA), personal handy phone system (PHS), lap top and desk top computers, TV's, GPS's or navigation systems, pedometers, health equipment, display monitors, and the like.

As would be apparent to one of ordinary skill in the art after reading this description, these are merely examples and the embodiments of the disclosure are not limited to operating in accordance with these examples. Other embodiments may be utilized and structural changes may be made without departing from the scope of the exemplary embodiments of the present disclosure.

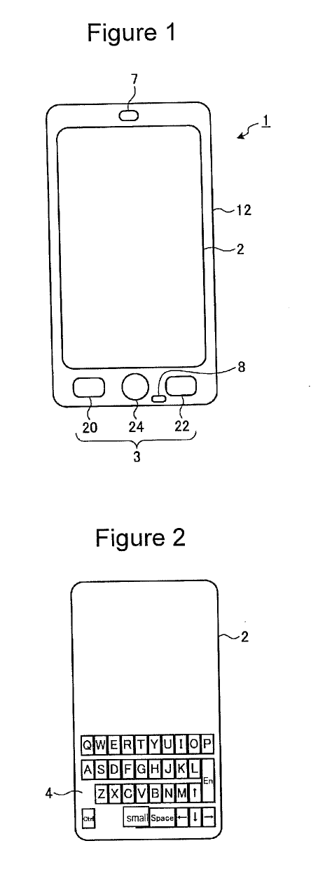

FIG. 1 is a front view showing an external appearance of a mobile phone terminal 1, used as a character input device. The mobile phone terminal 1 comprises a lamellar housing 12 (housing 12). A touch panel 2; an input module 3 comprising a button 20, a button 22 and an input device 24; a receiver 7; and a microphone 8 are located on a surface of the housing 12. The touch panel 2 is disposed at the surface on which the tabular housing 12 (housing 12) is the widest.

The input module 3 is also disposed on one end in a longitudinal direction, at the surface on which the touch panel 2 of the housing 12 is disposed. The input module 3 is disposed in the order of the button 20, the input device 24, and the button 22, facing from one side of the transverse direction towards the other side.

The receiver 7 is disposed at the edge of another side in the longitudinal direction at the surface on which the touch panel 2 of the housing 12 is disposed, that is, the receiver 7 is disposed at an edge on an opposite side from an edge on which the input module 3 is disposed. The receiver 7 is disposed at an edge of one end of the longitudinal direction at the surface on which the touch panel 2 of the housing 12 is disposed, that is, the receiver 7 is disposed at the edge region on which the input module 3 is disposed.

The touch panel 2 displays characters, figures, images, and the like, while simultaneously detecting various actions that are performed on the touch panel 2 using input means such as but without limitation, fingers, styluses, pens (the edge of a pen and the edge of a rod shaped member), and the like, (hereinafter simply referred to as a “finger”).

FIG. 2 shows a virtual keyboard 4 displayed on the touch panel 2. For example, the mobile phone terminal 1 displays a virtual keyboard 4 on the touch panel 2 in order to receive character inputs from a user.

The mobile phone terminal 1, in a state in which the virtual keyboard 4 is displayed on the touch panel 2, detects various actions input to the touch panel 2 using the fingers, detects which keys are pressed and brought into contact, and by regarding the keys in which pressing and contact have is detected as input keys, the virtual keyboard 4 performs character input. Regardless of the characters input, based on images displayed and various actions performed on the touch panel 2 using the fingers, the touch panel 2 detects various operations input, and performs various controls based on the operations input.

When the buttons 20 and 22 are pressed, the input module 3 initiates the function corresponding to respective buttons 20 and 22 that are pressed. The input module 3 also detects the action input to the input device 24 as an operation input, and performs various controls based on the operation input.

The input device 24 is explained below.

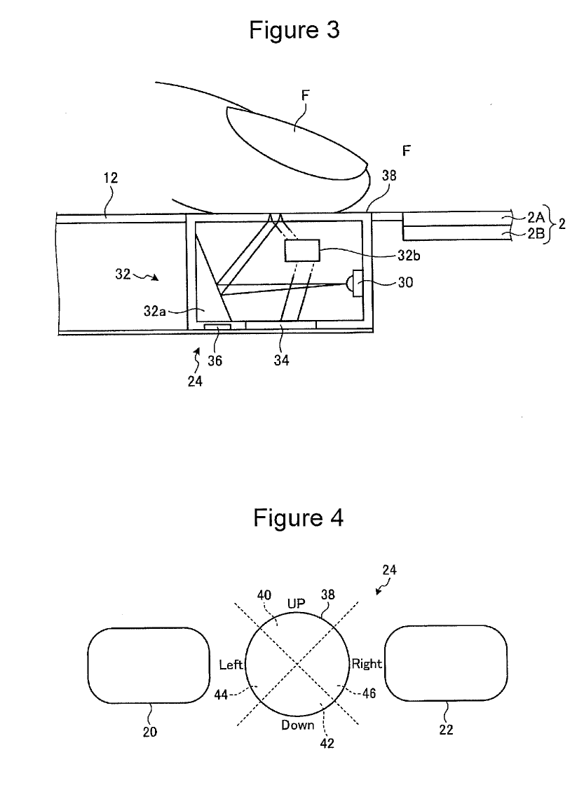

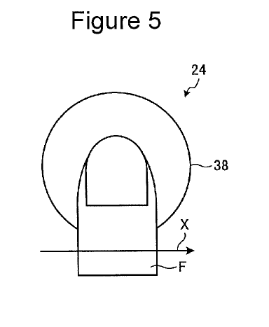

FIG. 3 is a cross-sectional diagram showing a schematic configuration of the input device 24. FIG. 4 is a surface diagram showing a schematic configuration of the input device 24. FIG. 5 is an explanatory diagram for explaining one example of input actions.

The input device 24 comprises a light source 30, an optical unit 32, a sensor 34, a processing module 36, and a contact surface 38. By detecting and analyzing the movement of a finger F that comes in contact with the contact with surface 38 that is exposed to the surface of the housing 12, an operation input by the finger F is detected.

In an embodiment, the movement of the finger F is detected and analyzed; however, as long as changes in contact can be detected, that is, as long as movement can be detected, any input means can be used as an object for inputting the operation. The input means may comprise, for example but without limitation, fingers, styluses, pens, or the like.

The contact surface 38 is formed of materials in which the characteristics of optical reflection change, as the subject such as the finger F comes in contact with the surface. The exposed surface of the contact surface 38 has a circular shape. The touch panel 2 is disposed in a vicinity of the input device 24, and the touch panel 2 comprises a display module 2B and a touch sensor 2A that is superimposed on the display module 2B.

The light source 30 outputs light. The light source 30 may comprise, for example but without limitation, LEDs, laser diodes, and the like. It is preferable that a light source that outputs light at a fixed wavelength, specifically, a light source that outputs light at the wavelength of the invisible area, be used. By using light at the wavelength of the invisible area, even if light is emitted externally from the contact surface 38, it is possible to make it not be recognized and control it such that a user is not dazzled. Because the optical unit is easily made, a light source that emits light with high directivity may be used.

The optical unit 32 is a mechanism that, after the light that is output from the light source 30 is directed to reach the contact surface 38, constitutes an optical path that directs the light to the sensor 34, and comprises a mirror 32a and an optical system 32b. The mirror 32a reflects the light that is output from the light source 30, and deflects the light toward the contact surface 38. The optical system 32b comprises optical members that condense and refract light, and it deflects the light that is reflected on the contact surface 38 towards the sensor 34.

The sensor 34 is a photo detection element that detects the light that is reflected at the contact surface 38. The sensor 34 comprises the plane detection surface, and obtains images of the contact surface 38 by detecting the distribution of light intensity that is incident to each position on the plane surface. The sensor 34 transmits the detected results (images) to the processing module 36. The processing module 36 is an input processing module (DSP), and based on the detection results at the sensor 34, it detects movement by the finger F. The processing module 36 is subsequently explained.

For the input device 24, guiding the light that is output from the light source 30 with the optical unit 32 causes it to reflect on the contact surface 38, subsequently making it incident to the sensor 34. Subsequently, the input device 24 detects the shape of the finger F (subject) that is in contact with the contact surface 38 by transmitting information on the distribution of the light that is incident at the sensor 34 to the processing module 36 and by analyzing the detection results at the processing module 36. By repeatedly detecting the shape of the finger F that is in contact with the contact surface 38 in this way for each fixed time, the input device 24 detects changes in the shape of the finger F that is in contact with the contact surface 38, that is, it detects movement of the finger F and any shift of the finger F.

The input device 24 detects unevenness of the finger F (fingerprint, etc.) by detecting the image of the finger F, and by detecting the characteristics from the fingerprint and any movement of these characteristics, it detects the movement of the finger. In FIG. 3, the state in which only one section of the contact surface 38 is detected is shown; however, by disposing multiple similar units, the image of the entire area of the contact surface 38 can be obtained (detected).

For the input device 24, as shown in FIG. 4, the area of the contact surface 38 is set by dividing it into a first area 40, a second area 42, a third area 44, and a fourth area 46. Here, the first area 40 is the area between 315° and 45°, assuming that the point closest to the touch panel 2 is set to 0°, by setting the center of the contact surface 38 as the center. Similarly, the second area 42 is the area between 135° and 225°. The third area 44 is the area between 225° and 315°. The fourth area 46 is the area between 45° and [symbol] .

For example, for cases in which the image in which the longitudinal direction is set to be in the vertical direction is displayed on the touch panel 2, if the input device 24 detects that the finger F (arbitrary characteristics of the finger F) has moved from the first area 40 to the second area 42, it determines that for the operation subject, such as a cursor, a command to move in the downward direction is input. As shown in FIG. 5, if the finger F moves in the X direction and if the input device 24 detects that the finger F has moved from the third area 44 to the fourth area 46, it determines that for the operation subject, a command to move the finger in the rightward direction is input. In this way, the input device 24 divides the area, and by detecting from which area to which area the finger moves, it can determine to which direction the operation for moving the finger is input, from among the upward, downward, leftward and right ward directions. That is, the input device 24 can be suitably used as a direction key.

Next, the relationship between the function of the mobile phone terminal 1 and a control module is explained.

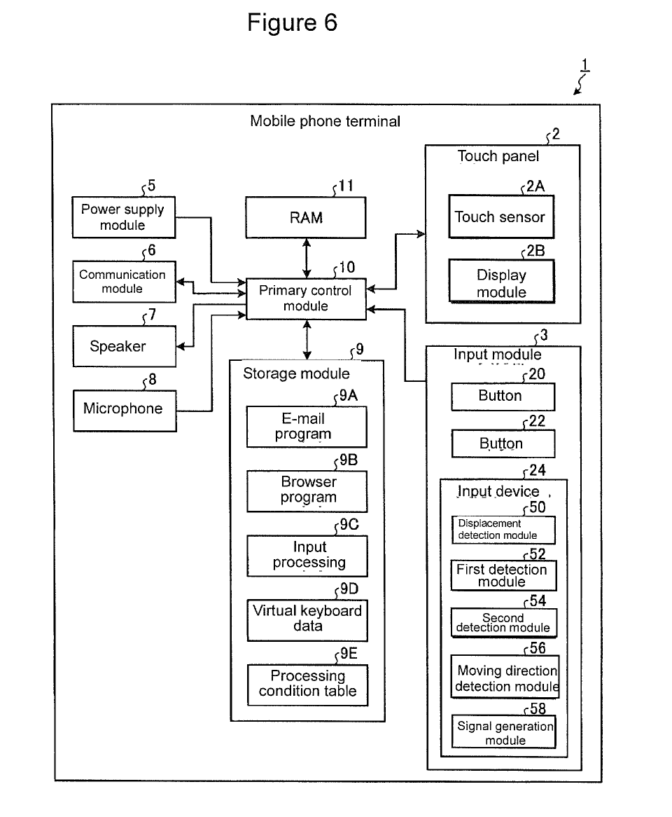

FIG. 6 is a block diagram showing the schematic configuration of functions of the mobile phone terminal 1. The mobile phone terminal 1 comprises the touch panel 2; the input module 3; a power supply module 5; a communication module 6; the receiver 7; the microphone 8; a storage module 9; a primary control module 10; and a RAM 11.

The touch panel 2, as described above, comprises the display module 2B; and the touch sensor 2A that is superimposed on the display module 2B. The touch sensor 2A detects various actions performed with respect to the touch panel 2 using the finger, along with the position on the touch panel 2 on which the action is performed. The actions detected by the touch sensor 2A may comprise, for example but without limitation, the action causing the finger to come in contact with the surface of the touch panel 2, the action causing the finger to move while maintaining the finger to be in contact with the surface of the touch panel 2, the action releasing the finger from the surface of the touch panel 2, and the like. The touch sensor 2A may use any detection method such as a pressure-sensitive type and an electrostatic type. The display module 2B may comprise for example but without limitation, a liquid-crystal display, an organic EL panel. The touch panel 2 may display, for example but without limitation, characters, figures, images, and the like.

The input module 3, as described above, comprises the buttons 20 and 22, and the input device 24. The buttons 20 and 22 receive the operation by the user through physical inputs (hold down) and transmit the signals corresponding to the received operation to the primary control module 10. The input device 24 is subsequently described.

The power supply module 5 supplies the electric power obtained from a storage battery or an external power source to each function module of the mobile phone terminal 1, comprising the primary control module 10. The communication module 6 establishes wireless signal communications with a base station using a communication protocol, such as but without limitation, Code Division Multiple Access (CDMA), and the like. The communication module 6 establishes wireless signal communications with a base station through a communication channel allocated by the base station, and performs phone communications and information communications with the base station. The receiver 7 outputs sounds, ringtones, etc., of an intended party as phone communications. The microphone 8 converts the sounds of the user, etc., into electrical signals.

The storage module 9 is, for example, a nonvolatile memory or magnetic storage, and it stores programs and data used for processing at the primary control module 10. Specifically, the storage module 9 stores an e-mail program 9A for transmitting and receiving e-mails and for viewing e-mails; a browser program 9B for viewing WEB pages; an input processing program 9C for determining a control action, a text edit action, and processing, based on the input operation that is input to the input device 24; and virtual keyboard data 9D that comprises a definition with regard to the virtual keyboard 4 that is displayed on the touch panel 2 during character input; and a processing condition table 9E that comprises conditions that associate the input operation detected with the input processing and the control actions. The storage module 9 also stores an operating system program that achieves basic functions of the mobile phone terminal 1 and other programs and data such as address book data into which names, telephone numbers, e-mail addresses, etc., are registered. The storage module 9 also stores programs that determine the control action and processing, based on the input operation that is input to the touch panel 2. For control action and processing, various actions and processing performed with the mobile phone terminal 1 may comprise for example but without limitation, movement of a cursor and a pointer, a display switch of the screen, character input processing, various application start processing, end processing, and the like.

The primary control module 10 comprises a CPU and controls the actions of the mobile phone terminal 1 in a controlled manner. Specifically, the primary control module 10 refers to the data stored in the storage module 9 as necessary, while simultaneously executing the program stored in the storage module 9, and executing various processing by controlling the touch panel 2, the input module 3, the communication module 6, etc. The primary control module 10 deploys obtained/generated/processed data to the RAM 11 that provides the temporary storage area, by executing programs and processing that are stored in the storage module 9. The programs and data that the primary control module 10 executes and refers to may be downloaded from a server device, using wireless communications methods.

Next, the input device 24 is explained. FIG. 6 is a block diagram showing the schematic configuration of functions of the mobile phone terminal. The input device 24 comprises a displacement detection module 50; a first detection module 52; a second detection module 54; a moving direction detection module 56; and a signal generation module 58.

Some of the displacement detection module 50, the first detection module 52, the second detection module 54, the moving direction detection module 56, and the signal generation module 58 are function modules for performing arithmetic processing, and are executed by the processing module that constitutes the processing module 36. Functions of some of the displacement detection module 50, the first detection module 52, the second detection module 54, the moving direction detection module 56, and the signal generation module 58 may be executed by one application software and program, or they may be executed with separate application software and programs for each function.

In an embodiment, the processing module 36 and the primary control module 10 are provided separately; however, both functions may be executed by one CPU. Some functions of the processing module 36 may be performed by the primary control module 10.

In one embodiment, when multiple items that can be selected with a cursor are disposed in a row on the display module 2B based on a display rule and a screen in which one of the items is specified by the cursor is displayed, the control module is operable to change a fixed number of items in a list that causes the items to be displayed on the display module 2B based on the display rule if a first control signal is input; and switch an item specified by the cursor to an adjacent item if a second control signal is input.

The displacement detection module 50 comprises the light source 30; the optical unit 32; the sensor 34; some functions of the processing module 36; and the contact surface 38, as described above. The displacement detection module 50 comprises a detection surface that is disposed in the housing 12, and is operable to detect a displacement of a substance that is brought into contact with the detection surface. In this manner, the displacement detection module 50 detects displacement (movement) of the subject (input means) by obtaining and analyzing the image of the contact surface 38, resulting from the above processing. In one embodiment, the displacement detection module 50 continuously capture images of the substance that is brought into contact with the detection surface, process the images, and detect the displacement based on a displacement of characteristics of the substance.

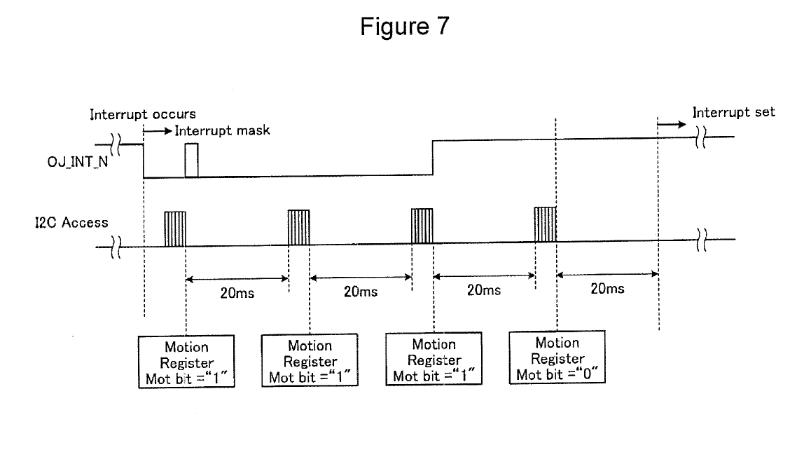

FIG. 7 is an explanatory diagram for explaining the action of the input device. The displacement detection module 50 performs detection (obtains polling data) for each fixed time (20 ms), and if it detects changes in the image on the contact surface or if detects any contact, it initiates processing to detect the displacement.

The first detection module 52 detects the displacement amount (instantaneous value) for each time unit, based on information of the image detected in the displacement detection module 50 or information of the displacement of the subject. The first detection module 52 detects the displacement amount for each time unit and detects the detected displacement amount as the instantaneous value. The time unit can be set in various ways, that is, it may be set to a fixed time that is set, and for example, it may be performed each time detection is performed at the displacement detection module 50, or it may be performed each time the set time elapses. The first detection module 52 transmits the instantaneous value to the signal generation module 58.

The second detection module 54 integrates the instantaneous value that is detected at the first detection module 52, and calculates the integrated value of the displacement amount. That is, the second detection module 54 calculates the total displacement amount from when integration started. In an embodiment, the instantaneous value detected at the first detection module 52 was used; however, the instantaneous value may be calculated by separate processing from the first detection module 52, so as to integrate the displacement amount. That is, the second detection module 54 may be such that the integrated value of the displacement detected at the displacement detection module 50 can be detected, and the detection method thereof is not limited. The second detection module 54 transmits the integrated value of the displacement amount detected to the signal generation module 58. For the second detection module 54, if a command to initialize the integrated value is input from the signal generation module 58, and the like, the second detection module 54 initializes the integrated value, that is, the second detection module 54 sets the integrated value to 0, and using the instantaneous value that is detected following initialization, the second detection module 54 initiates integration of the displacement amount again.

The moving direction detection module 56 is operable to detect the moving direction of the substance based on differences in a subject that is detected in the displacement detection module 50. The primary control module 10 is operable to perform a predefined function based on the moving direction that is detected in the moving direction detection module 50. The moving direction detection module 56 detects the direction of the displacement detected at the displacement detection module 50, and detects the direction in which the subject moved. That is, the moving direction detection module 56 detects whether the subject moved from any area, namely from the first area 40 to the fourth area 46, to any area, namely from the first area 40 to the fourth area 46, and transmits the information of the moving direction that is detected to the signal generation module 58.

The signal generation module 58 generates operation signals (control signal) and transmits the generated operation signals to the primary control module 10 (control module) based on the information transmitted from the first detection module 52, the second detection module 54, and the direction detection module 56. First, for the signal generation module 58, thresholds are set with respect to the instantaneous value and the integrated value of the displacement amount, respectively. Specifically, with respect to the instantaneous value, a threshold of the displacement amount (displacement threshold and a speed detection level), which is the threshold of the displacement amount, is set, and with respect to the integrated value of the displacement amount, a threshold of the integrated value, which is the threshold of the integrated value of the displacement amount (integration threshold and a key detection level), is set. When the displacement amount is used as the base, the threshold of the displacement amount is set higher than the threshold of the integrated value.

The signal generation module 58 compares the instantaneous value that is transmitted from the first detection module 52 and the threshold, compares the integrated value of the displacement amount transmitted from the second detection module 54 and the threshold, and based on the comparison results, generates the operation signals. In the present embodiment, for the signal generation module 58, if the instantaneous value transmitted from the first detection module 52 exceeds the threshold of the displacement amount, it generates a first operation signal, and if the integrated value of the displacement amount transmitted from the second detection module 54 exceeds the threshold of the integrated value, it generates a second operation signal.

For the signal generation module 58, at the same detection timing, for cases in which the instantaneous value that is transmitted from the first detection module 52 exceeds the threshold of the displacement amount and in which the integrated value of the displacement amount transmitted from the second detection module 54 exceeds the threshold of the integrated value, it generates the first operation signal. The signal generation module 58 generates the first operation signal or the second operation signal, and if the generated operation signals are output to the primary control module 10, it outputs an initialization command of the integrated value to the second detection module 54. Therefore, for the second detection module 54, each time the first operation signal and the second operation signal are transmitted to the primary control module 10, the integrated value is initialized.

The signal generation module 58 generates operation signals that show the moving direction, based on the information of the moving direction that is transmitted from the moving direction detection module 56, and transmits them to the primary control module 10. The signal generation module 58, when generation the first operation signal or the second operation signal, even if it is set so as to generate the operation signals that show the moving direction, regardless of the generation of the first operation signal and the second operation signal, may generate operation signals that show the moving direction.

The input device 24 detects the user input with both the instantaneous value and the integrated value of the displacement amount, and based on the detection results, generates varying operation signals. That is, the input device 24 executes the instantaneous value control and the integrated value control, in parallel with each other.

Next, detection action of the input device is described.

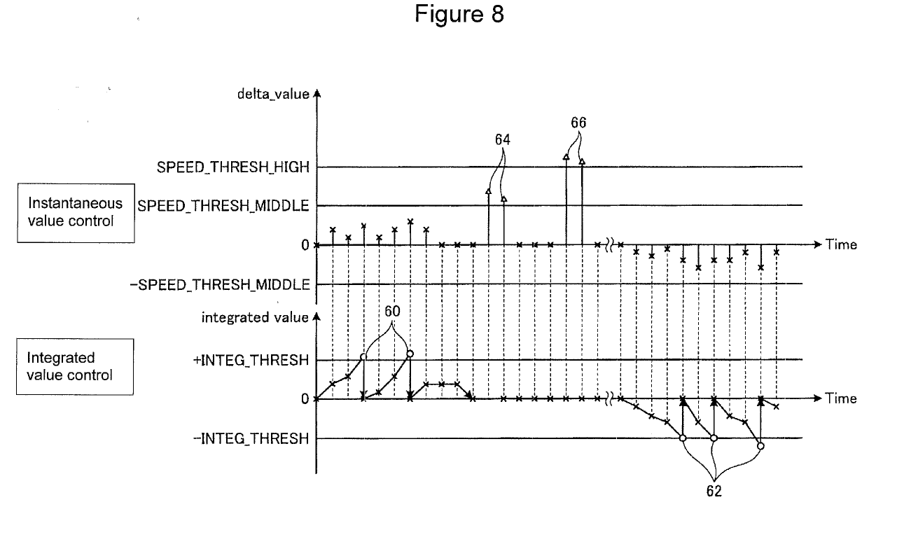

FIG. 8 to FIG. 10 are explanatory diagrams for explaining the action of the input device. FIG. 8 is a graph showing the relationship between the detected instantaneous value and the integrated value; and the time. The vertical axis represents the displacement amount (instantaneous value) or the integrated value and the horizontal axis represents time. FIG. 8 is a state in which the displacement in an arbitrary linear direction, for example, the displacement vertically and horizontally, is detected.

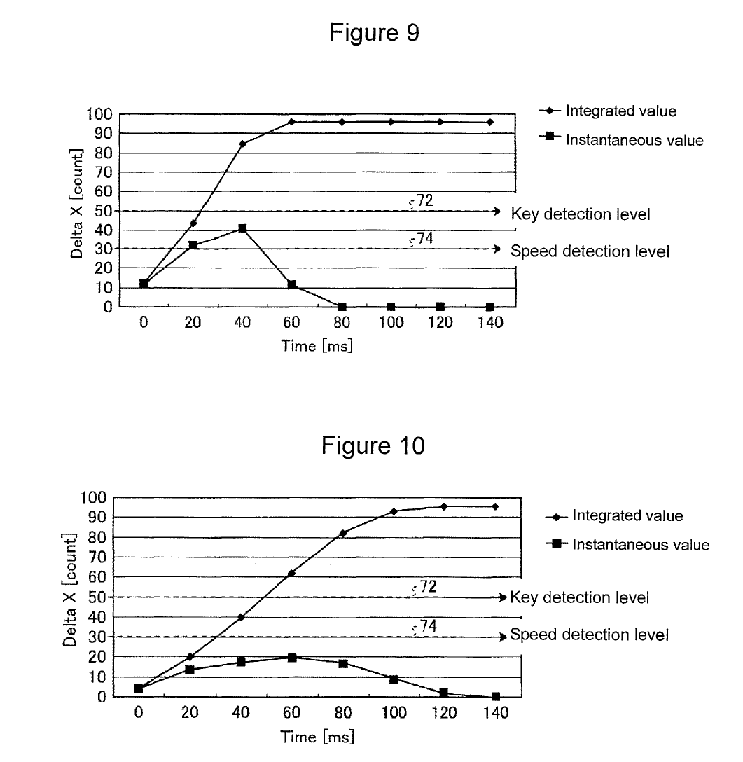

FIGS. 9-10 are graphs showing the relationship between the instantaneous value and the integrated value vs. time, when the input device 24 detects the operation once. In FIG. 9 and FIG. 10, the vertical axis is set to the displacement amount (ΔX) (count) and the horizontal axis is set to time (ms). The unit of the displacement amount, namely count, is a detection unit of the displacement amount with the input device (for example, the number of pixels moved).

Based on the value detected at the displacement detection module 50, as the input device 24 detects the instantaneous value at the first detection module 52, as shown in FIG. 8, it can calculate the displacement amount for each time unit. Based on the value detected at the displacement detection module 50, as it detects the integrated value of the displacement amount at the second detection module 54, it can calculate the integrated value of the displacement amount for each time unit. Based on the detection results of the moving direction detection module 56, by detecting the moving direction, it can detect whether the displacement is the displacement amount in the positive direction or in the negative direction (opposite direction from the positive direction). The signal generation module 58 performs instantaneous value control based on the detected instantaneous value and the integrated value control based on the integrated value, in parallel. In the example shown in FIG. 8, as the threshold of the integrated value, “INTEG_THRESH” is set, and as the threshold of the displacement amount, “SPEED_THRESH_HIGH”, which has a larger displacement amount than “SPEED_THRESH_MIDDLE” and “SPEED_THRESH_MIDDLE”, is set. The thresholds of the displacement amount shown in FIG. 8 are reference values, and changes according to the elapsed time are not taken into consideration.

If the integrated value exceeds the threshold, without the instantaneous value exceeding the threshold, that is, if singular points 60 and singular points 62 are reached, the signal generation module 58 generates the second operation signal. If the signal generation module 58 detects a displacement amount exceeding the threshold, as the instantaneous value, that is, if it detects an instantaneous value reaching singular points 64 and 66, it generates the first operation signal. If the signal generation module 58 detects the singular points 60, 62, 64, and 66, and if it generates the operation signals, it initializes the integrated value, and sets it to 0.

For the signal generation module 58, by performing the control as explained above, for example, as shown in FIG. 9, because the integrated value exceeds a threshold 72, that is, because it exceeds a Key detection level (threshold of the integrated value), and at the same time, because the instantaneous value exceeds a threshold 74, that is, because it exceeds a speed detection level (threshold of the displacement amount), when the time reaches 20 ms, it determines that the finger is moved at a speed faster than a fixed speed, and generates the first operation signal.

For the signal generation module 58, for example, as shown in FIG. 10, if the integrated value exceeds the threshold 72 before the instantaneous value exceeds the threshold 74, when the time reaches 40 ms, it determines that the finger is moved at a speed equal to or less than a fixed speed and for more than a fixed distance, and generates the second operation signal.

Next, actions for cases in which the mobile phone terminal 1 receives operations to the input device 24 are explained.

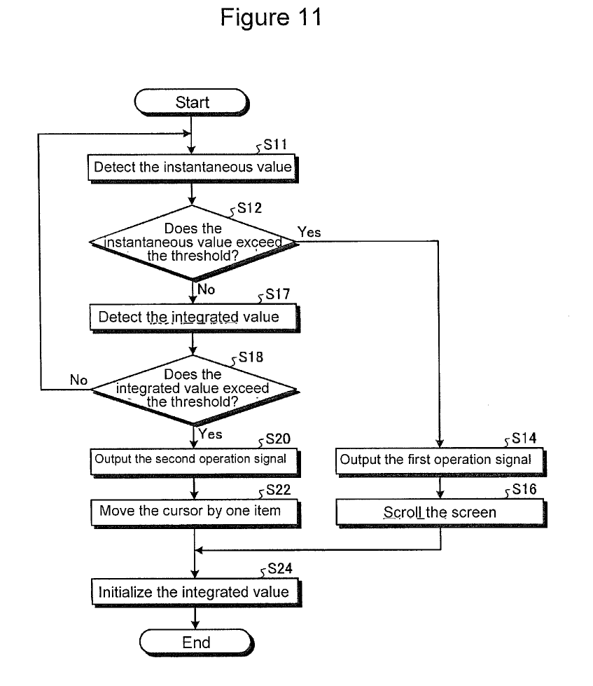

FIG. 11 is a flow diagram showing one example of the actions of the mobile phone terminal.

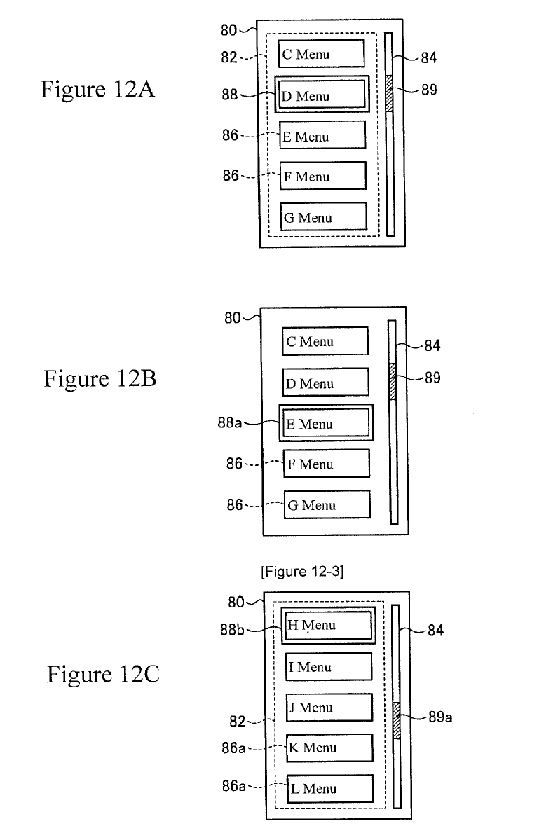

FIGS. 12A-12C are exemplary diagrams for explaining the actions of the mobile phone terminal. FIG. 11 and FIG. 12A to FIG. 12C represent one example of the actions of the mobile phone terminal 1 and the input device 24 for cases in which multiple items are displayed on the list on the display module 2B of the touch panel 2. In this example, the image for the items to be displayed on the display module 2B is larger than the display area of the display module 2B. That is, this is an example of a case in which a list is displayed having numerous numbers of items, which cannot be displayed all at once on the display module 2B. Each action of the mobile phone terminal 1, shown in FIG. 11 and FIG. 12A to FIG. 12C, is processed by performing transmission and receipt of information at both the processing module 36 of the input device 24 and at the primary control module 10.

First, the mobile phone terminal 1, as at task S11, detects the instantaneous value from the first detection module 52 of the input device 24. After the mobile phone terminal 1 detects the instantaneous value at task S11, as at task S12, it determines, from the signal generation module 58, whether the detected instantaneous value exceeds the threshold (threshold of the displacement amount), that is, it determines whether the threshold of the displacement amount is smaller than the instantaneous value.

If the mobile phone terminal 1 determines that the instantaneous value exceeds the threshold at task S12 (Yes at task S12), that is, if it determines that the threshold of the displacement amount is smaller than the instantaneous value, as at task S14, it generates the first operation signal at the signal generation module 58, and outputs the first operation signal to the primary control module 10. Subsequently, the mobile phone terminal 1, as at task S16, scrolls the screen, as instructed by the primary control module 10. Here, if the primary control module 10 receives the first operation signal, it extracts and decides the action with respect to the first operation signal from the condition table and performs the action that is decided upon. In this example, for cases in which multiple items (objects) are displayed on the list on the screen, the action to scroll the display for 1 screen (items for a fixed number) is mapped to the first operation signal. Based on this, when the primary control module 10 receives the first operation signal, it scrolls the screen by 1 screen. The direction in which the screen is scrolled is the direction that is mapped in the displacement direction of the subject. After the mobile phone terminal 1 ends the processing at task S16, it proceeds to task S24.

After the mobile phone terminal 1 determines at task S12 that the instantaneous value does not exceed the threshold (No at task S12), that is, if it determines that the threshold of the displacement amount is equal to or larger than the instantaneous value, as at task S17, it detects the integrated value from the second detection module 54. This processing at task S17 may be performed simultaneously with task S11. After the mobile phone terminal 1 detects the integrated value at task S17, as at task S18, it determines whether the detected integrated value exceeds the threshold (threshold of the integrated value), that is, it determines whether the threshold of the integrated value is smaller than the integrated value. If the mobile phone terminal 1 determines that at task S18 the integrated value does not exceed the threshold (No at task S18), that is, if it determines that the threshold of the integrated value is equal to or larger than the integrated value, it proceeds to task S11 and repeats the above processing. That is, the mobile phone terminal 1 (the input device 24) repeats the processing of task S11, task S12, task S17, and task S18 until either the instantaneous value or the integrated value exceeds the threshold.

If the mobile phone terminal 1 determines that the integrated value exceeds the threshold at task S18 (Yes at task S18), that is, if it determines that the threshold of the integrated value is smaller than the integrated value, as at task S20, it generates a second operation signal at the signal generation module 58, and outputs the second operation signal to the primary control module 10. Subsequently, as at task S22, the mobile phone terminal 1 moves the cursor by one item, as instructed by the primary control module 10. Here, if the primary control module 10 receives a second operation signal, it extracts and decides the action with respect to the second operation signal from the condition table and performs the action that is decided upon. In the present example, for cases in which multiple items are displayed on the list on the screen, an action by which the cursor that specifies the item is moved to the one adjacent item is associated with the second operation signal. Therefore, if the primary control module 10 receives a second operation signal, it moves the cursor that is displayed on the screen by one item. The direction in which the cursor is moved is the direction corresponding to the displacement direction of the subject. After the mobile phone terminal 1 ends the processing at task S16, it proceeds to task S24.

After the mobile phone terminal 1 performs the processing at task S16 or at task S22, as at task S24, it initializes the integrated value that is calculated at the second detection module 54, sets it to 0, and subsequently, it ends the processing. While the state in which the image is displayed is continued, that is, while the application is being performed, the mobile phone terminal 1 repeatedly performs the above processing.

Based on the processing shown in FIG. 11, as the mobile phone terminal 1 operates the input device 24, it can perform the following control. First, to the mobile phone terminal 1, as shown in FIG. 12A, multiple items 86 are displayed on the list (arranged) on an area 82 of a screen 80, and to the area 82, a referential index 89 is displayed on a bar 84. Here, as the item 86, five items 86, the “C menu,” “D menu,” “E menu,” “F menu,” and “G menu,” are displayed, and the item 86 for “D menu” is specified by a cursor 88. The bar 84 and the referential index 89 show which area is displayed on the screen 80, among the entire image that is created by the application. That is, the bar 84 and the referential index 89 are associated with the positional relationship between the entire image and the image displayed on the screen 80.

When the mobile phone terminal 1, in the state of the screen shown in FIG. 12A, detects the second operation signal with the moving direction being downwards, as shown in FIG. 12B, it moves the position of a cursor 88a such that the cursor 88a reaches the state in which it specifies the item 86 for the “E menu.”

When the mobile phone terminal 1, in the state of the screen shown in FIG. 12A, detects the first operation signal with the moving direction being downwards, as shown in FIG. 12C, it switches items 86a to be displayed on the display area 82 to five items 86a, the “H menu,” “I menu,” “J menu,” “K menu,” and “L menu.” Here, the item 86a is the item disposed below the item 86 for the “G menu,” with regard to the positional relationship for the entire screen. That is, the mobile phone terminal 1 moves the items to be displayed on the area 82 by one screen and replaces all the items to be displayed. As the items to be displayed are replaced, the position of a display index 89a moves downwards. A cursor 88b reaches the state in which the item 88 for the “H menu” is specified.

As above, as the mobile phone terminal 1 detects the displacement amount to be detected as the operation to be input to the input device 24 with both the instantaneous value and the integrated value, and as it switches the operation to be executed based on the detected value, a user can perform the input operation, that is, a user can input varying operations, simply by changing the speed at which the finger is slid. Therefore, it is possible to increase operations that can be performed by the input of the input device 24.

The user can perform intuitive operations as the input speed (moving speed of the finger and moving speed of the subject) performs fast inputs, and as the processing, which can be achieved by performing multiple times the processing resulting from the inputs with the slow input speed, is performed. Because it is no longer necessary to input the operations multiple times, it is possible to perform the operation in a short period of time, requiring less time for the operation.

For the mobile phone terminal 1, by setting the relationship between the threshold of the displacement amount and the threshold of the integrated value such that the threshold of the displacement amount is smaller than the threshold of the integrated value, the possibility of the second operation signal being output despite the operation being input quickly can be reduced. In this way, the operation intended by the user can be easily preformed.

The mobile phone terminal 1 may set the threshold of the displacement amount with multiple values, and for example, as shown in FIG. 8, it may set in two stages, and for the respective threshold of the displacement amount, it may cause varying operation signals to be output and varying operations to be performed. In this way, by setting the threshold of the displacement amount with multiple values and by causing each varying processing to be performed, it is possible to input many various types of operations with the input device 24.

It is preferable that the input device 24 processes the first detection module 52 and the second detection module 54, in parallel with each other. In this way, the processing time can be set to be short.

In the above embodiment, cases of the scroll operation of the screen and the movement operation of the cursor are explained as examples; however, the embodiments of the disclosure are not limited to this, and using the input device, it can be associated with various operations. Here, as the operation to input with the input device, there are various operations that can be performed by inputting, using what is termed a pointing device, such as a mouse, a joy stick, or a trackball, and the movement of the cursor and the movement of the pointer, the scrolling of the screen, etc., can be mentioned. For example, when the first operation signal is input, the cursor is moved to the edge of the screen, and when the second operation signal is input, control to move the cursor to the middle of the screen is possible.

According to one embodiment, the character input device comprises a selection function for scrolling and pagination as explained above in the context of discussion of FIG. 1 to FIG. 5.

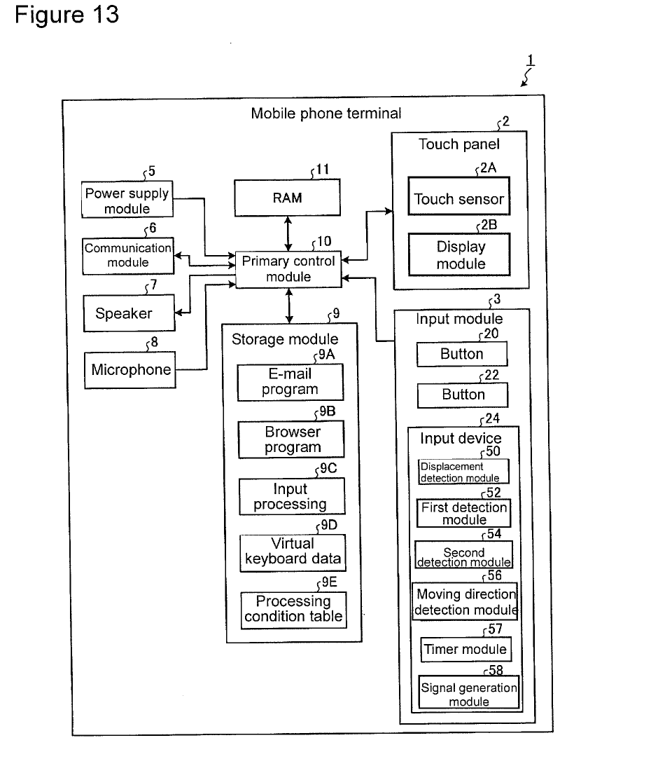

FIG. 13 is a block diagram showing the schematic configuration of functions of the mobile phone terminal. The input device 24 according to an embodiment differs from the input device 24 in FIG. 6 in that it further comprises a timer module 57. Embodiment shown in FIG. 13 may have functions, material, and structures that are similar to the embodiments shown in FIG. 6. Therefore common features, functions, and elements may not be redundantly described here. In the present embodiment, with respect to the instantaneous value, a speed detection level is set as the threshold of the displacement amount.

The timer module 57 is a measuring module that measures the elapsed time from the start of measurement. The timer module 57 starts measuring the elapsed time, based on the information that is transmitted from the signal generation module 58. Specifically, after measurement of the input that generated the first operation signal, which is described subsequently, is completed, or after measurement of the input that generated the second operation signal is completed, measuring of the elapsed time is initiated. That is, it treats the end (completion) of the input that generated the first operation signal or the second operation signal as a trigger to start measurement. The timer module 57 transmits the measured elapsed time to the signal generation module 58.

The signal generation module 58 generates operation signals (control signal) and transmits the generated operation signals to the primary control module 10 (control module) based on the information transmitted from the first detection module 52, the second detection module 54, and the direction detection module 56. First, for the signal generation module 58, thresholds are set with respect to the instantaneous value and the integrated value of the displacement amount, respectively. Specifically, with respect to the instantaneous value, a threshold of the displacement amount (a speed detection level), which is the threshold of the displacement amount, is set, and with respect to the integrated value of the displacement amount, a threshold of the integrated value, which is the threshold of the integrated value of the displacement amount (a key detection level), is set. When the displacement amount is used as the base, the threshold of the displacement amount is set higher than the threshold of the integrated value.

The signal generation module 58 sets the threshold of the displacement amount, based on the elapsed time. Specifically, in the signal generation module 58, the relationship between the elapsed time and the displacement amount of the threshold is stored, and based on the elapsed time that is measured in the timer module 57, the displacement amount of the threshold is determined. In the present embodiment, the shorter the elapsed time, the higher the threshold of the displacement amount is set by the signal generation module 58. That is, the shorter the elapsed time, the larger the displacement amount of the threshold is set by the signal generation module 58, that is, it sets the displacement amount for the unit time for the instantaneous value, meaning, it sets the threshold of the moving speed of the subject, to a faster speed.

The signal generation module 58 generates the first operation signal or the second operation signal, outputs the generated operation signals to the primary control module 10, and furthermore, after the measurement of the input that generated the operation signals is completed, it inputs a command to the timer module 57 to start the measurement. In this way, the timer module 57 resets the elapsed time to 0 each time the first operation signal or the second operation signal is generated, and starts measuring the elapsed time. Completing the measurement of the input that generated the operation signals is in reference to the time at which the instantaneous value reaches 0, after it detects that it exceeds the threshold. When it detects that it exceeds the threshold, it may be determined that the measurement of the input that generated the operation signals is completed.

The input device 24 may set the threshold of the displacement amount, which is a criterion for the instantaneous value control, based on the elapsed time. That is, according to the elapsed time, the threshold of the displacement amount may be set to varying values.

Next, the detection action of the input device 24 is described.

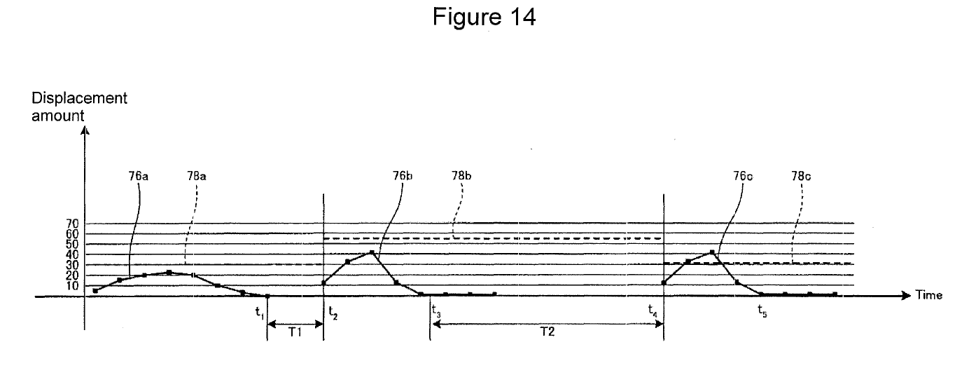

FIG. 14 is a graph showing the relationship between the threshold of the displacement amount and the elapsed time. The vertical axis represents the displacement amount and the horizontal axis represents time.

The mobile phone terminal 1 according to the present embodiment comprises the characteristics shown in FIG. 8 to FIG. 10. In order to avoid duplication, the same explanation is omitted.

The signal generation module 58 sets the threshold of the displacement amount to varying values, according to the elapsed time. First, the first detection module 52 detects a detection value 76a, which is the instantaneous value exceeding 0, during the period up to a time t₁, detects a detection value 76b, which is the instantaneous value exceeding 0, during the period between a time t₂ and a time t₃, and detects a detection value 76c, which is the instantaneous value exceeding 0, during the period between a time t₄ and a time t₅. All of the integrated values for the detection value 76a, the detection value 76b, and the detection value 76c are set to values exceeding the threshold of the integrated value.

Here, for the signal generation module 58, when the detection value 76a, which is the first value after measurement is started, is detected, a threshold 78a is set as the reference value (initial value) of the threshold of the displacement amount. None of the instantaneous values that constitute the detection value 76a exceed the threshold 78a. Therefore, when the integrated value exceeds the threshold of the integrated value, the signal generation module 58 generates and outputs the second operation signal. Subsequently, the signal generation module 58, when detecting the detection value 76b, calculates the threshold of the displacement amount, based on the elapsed time after the detection value 76a is detected. First, the detection value 76b is detected between the time t₁ and the time t₂, which is the time after a time T₁ elapses. The signal generation module 58 determines the threshold, based on the time T₁. In the present embodiment, because the time (elapsed time) T₁ is shorter than the reference time that is set, the signal generation module 58 sets a threshold 78b, which is higher than the threshold 78a, as the threshold. None of the instantaneous values that constitute the detection value 76b exceed the threshold 78b. Therefore, when the integrated value exceeds the threshold of the integrated value, the signal generation module 58 generates and outputs the second operation signal. For the detection value 76b, some of the instantaneous values exceed the threshold 78a.

Subsequently, the signal generation module 58, when detecting the detection value 76b, calculates the threshold of the displacement amount, based on the elapsed time after the detection value 76b is detected. First, the detection value 76c is detected between the time t₃ and the time which is a time after a time T₂ elapses. The signal generation module 58 determines the threshold, based on the time T₂. In the present embodiment, because the time (elapsed time) T₂ is longer than the reference time that is set, the signal generation module 58 sets a threshold 78c, which is the same value as the threshold 78a, as the threshold. Some of the instantaneous values that constitute the detection value 76c exceed the threshold 78c. Therefore, when the instantaneous value exceeds the threshold 78c, the signal generation module 58 generates and outputs the first operation signal.

In this manner, as the signal generation module 58 sets the threshold based on the elapsed time, even for cases in which an instantaneous value of the same size is detected, it can generate varying operation signals. By setting the threshold based on the elapsed time, it is possible to set an appropriate threshold according to usage.

Next, an action for cases in which the mobile phone terminal 1 receives the operation at the input device 24 is explained.

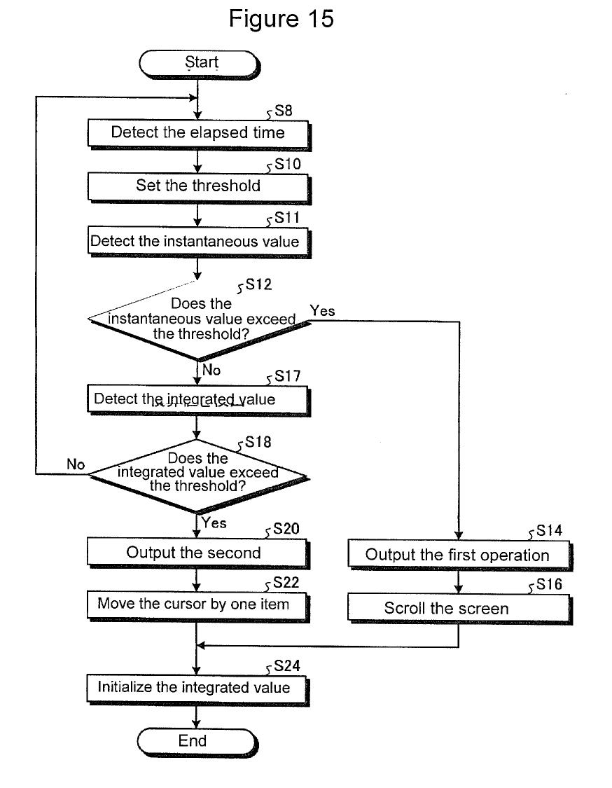

FIG. 15 is an illustration of an exemplary flow diagram of a mobile phone terminal according to an embodiment of the present disclosure. FIG. 15 is different from FIG. 11 in that it comprises task S8 and task S10.

The mobile phone terminal 1, as at task S8, detects the elapsed time from the timer module 57, and as at task S10, sets the threshold based on the elapsed time, from the signal generation module 58. The signal generation module 58 sets the threshold of the displacement amount based on the elapsed time. The signal generation module 58, at the initial input, sets the threshold of the displacement amount that is set as the criterion, as the threshold. After the mobile phone terminal 1 sets the threshold at task S10, as at task S11, it detects the instantaneous value from the first detection module 52 of the input device 24. When the mobile phone terminal 1 detects the instantaneous value at task S11, as at task S12, it determines from the signal generation module 58 whether the detected instantaneous value exceeds the threshold that is set at task S10 (threshold of the displacement amount), that is, it determines whether the threshold of the displacement amount is smaller than the instantaneous value.

After the input that generated the operation signals ends, the mobile phone terminal 1 temporarily resets measurement of the elapsed time from the timer module 57, that is, it sets it to 0. When initialization of the elapsed time and the integrated value is completed, it subsequently ends the processing.

As the mobile phone terminal 1 sets the threshold of the displacement amount according to the elapsed time, according to the input state, it can switch the threshold. That is, since the set value of the threshold can be set to varying values between cases in which the operation is continuously input with short intervals and cases in which it is input after a fixed time elapses, the operation according the use of the user can be easily detected.

As in the case with the present embodiment, for cases in which the operation is input with short time intervals, by setting the threshold of the displacement amount higher, the input speed (moving speed of the finger) for the subsequent input is faster than the input speed for the prior inputs; however, for cases of continuous inputs, which is the case in which the user wants to perform the same operation as immediately prior, after the second operation signal is detected, it can control by detecting the first operation signal. The threshold of the displacement amount may be set so as to change gradually according to the elapsed time, or it may be set so as to switch to other values, based on the elapsed time of a fixed threshold.

In the present embodiment, the shorter the elapsed time, the higher the setting of the threshold of the displacement amount; however, the present invention is not limited to this. For example, it may be set such that the shorter the elapsed time, the easier the same operation signals as the operation signal immediately prior are input. For example, for cases in which the operation signals immediately prior are the first operation signal, the shorter the elapsed time, the lower the threshold of the displacement amount may be set. Based on this, for cases in which the operation is input continuously with a short period of time, it is possible to set such that the same operation is input easily.

The mobile phone terminal 1 adds types of operation signals immediately prior, and, depending on whether the first operation signal is output or whether the second operation signal is output, it may change the value of the threshold. Based on this, the desired processing of the user can be easily input.

In the present embodiment, the setting of the threshold of the displacement amount was set so as to be switched; however, the threshold of the integrated value may be changed according to the elapsed time. For example, the shorter the elapsed time, the lower the threshold of the integrated value may be set. Based on this, the operation can be input with limited input (movement of the finger), thereby reducing the effort by the user.

In the state in which an image larger than the display area of the screen is displayed on the display module 2B, when the first operation signal is input, it may be switched to the area adjacent to the area that displayed the image to be displayed on the display module 2B immediately prior, and when the second operation signal is input, it may be switched from the area that displayed the image to be displayed on the display module 2B immediately prior to the area that is moved by a fixed distance. In the state in which an image larger than the display area of the screen is displayed on the display module 2B, when the second operation signal is input, it may calculate the movement based on the integrated value and switch from the area that displayed the image to be displayed on the display module 2B immediately prior to the area that is moved by the movement amount. Based on this, the image can be switched by the speed of the finger that inputs the scroll and the page break (movement for 1 page, entire replacement of the image that is displayed on the screen) to one input device.

Next, another action of the mobile phone terminal and the input device is explained.

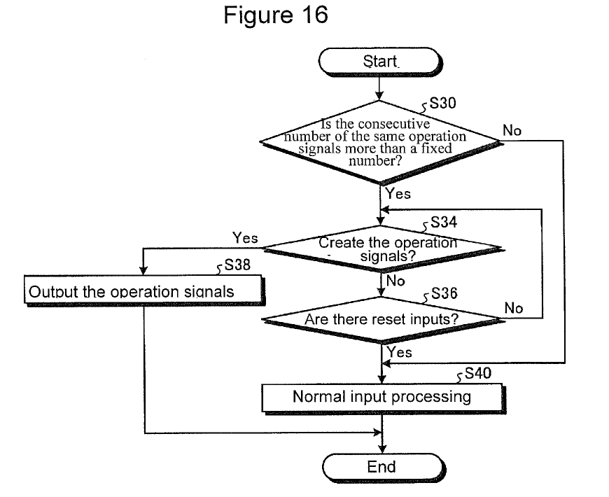

FIG. 16 is a flow diagram showing one example of actions of the mobile phone terminal. First, as at task S30, the input device 24 of the mobile phone terminal 1 determines whether the consecutive number of the same operation signals is more than a fixed number of times. That is, the input device 24 determines whether the same operation signals are generated continuously for more than the fixed number of times, at task S30. If the input device 24 determines at task S30 that the consecutive number of the same operation signals is less than the fixed number of times (No at task S30), it proceeds to S40.

If the input device 24 determines at task S30 that the consecutive number of same operation signals is more than the fixed number (Yes at task S30), as at task S34, it determines whether or not to create the operation signals. Here, as is the case with the above, if the integrated value exceeds the threshold of the integrated value, or if the instantaneous value exceeds the threshold of the displacement amount, the input device 24 determines to create the operation signals, and if none of the thresholds are exceeded, it determines that the operation signals are not created.

If the input device 24 determines at task S34 not to create the operation signals (No at task S34), as at task S36, it determines whether or not there are reset inputs. The reset inputs refer to inputs of commands to perform the processing that resets (deletes) the information of the signals input immediately prior. As reset inputs, various inputs can be presumed; however, it is the input of the operation in the direction different from the input direction that is presumed, for example, for cases in which the input of the operation vertically is continuously detected, it is the input of the operation horizontally. If the input device 24 determines at task S36 that there are no reset inputs (No at task S36), it proceeds to task S34, and repeats the above processing.

If the input device 24 determines at task S36 that there are reset inputs (Yes at task S36), it performs the reset processing, that is, it resets (deletes) the information of the signals input prior, and proceeds to task S40.

If the input device 24 determines at task S34 to create the operation signals (Yes at task S34), it generates the operation signals at task S38, and outputs the generated operation signals. The input device 24 generates the same operation signals as the operation signals output immediately prior, as the operation signals, and outputs them. After the input device 24 outputs the operation signals, it ends the processing.

If the input device 24 determines No at task S30 or Yes at S36, it performs normal input processing at task S40, and subsequently, ends the processing. Normal input processing refers to the processing at FIG. 15, described above. It is not necessary to set the threshold, resulting from the elapsed time of task S8 and task S10

In this way, the mobile phone terminal 1 and the input device 24, by performing the processing shown in FIG. 16, when the same operation signals are continuously input, and subsequently, when the condition to input the operation signals is met, regardless of the condition, can input the same operation signals as the operation signals input immediately prior. In this way, continuous inputs can be performed more easily.

If the rest inputs are performed, regardless of the number of times of continuous inputs, by performing normal processing by the arbitrary operation of the user, the setting can be cancelled, thereby making it easier to use.

By making the input in the direction perpendicular to (crosses with) the direction that is subjected so as to input the operation signals, as the reset inputs, the reset inputs can be performed by simple operations. The reset input can be input along with the input to the input device.

Even for cases of the processing shown in FIG. 16, as above, it is preferable that the threshold be set based on the elapsed time; however, the present invention is not limited to this. For cases of the processing shown in FIG. 16, the threshold may be set to be a fixed value. For cases in which the threshold is to be a fixed value, it may not be necessary to provide the timer part.

In the present embodiment, the second detection module 54 was provided; however, it is not necessary to use the integrated value of the instantaneous value. In the above embodiment, the first detection module 52, the second detection module 54, and the timer module 57 are parameter detection modules.

The above input modules (the input device and the control thereof) can be used for various electronic devices as described above; however, as described above, it is preferable that it be used specifically for the mobile phone terminal 1. For cases in which the devices are made so as to be small and thin, such as with mobile phone devices, specifically such as with the mobile phone terminal 1, and in which the area for the input module that can be disposed is small, various inputs are possible with one input device. As a result, the effect of the present invention can be more appropriately obtained.

According to one embodiment, the character input device comprises a text edit function, comprising the same configuration as the character input device described in FIG. 1 to FIG. 5. In order to avoid duplication, the same explanation is omitted.

In an embodiment, the storage module 9 can store the text edit action, based on the input operation that is input to the input device 24.

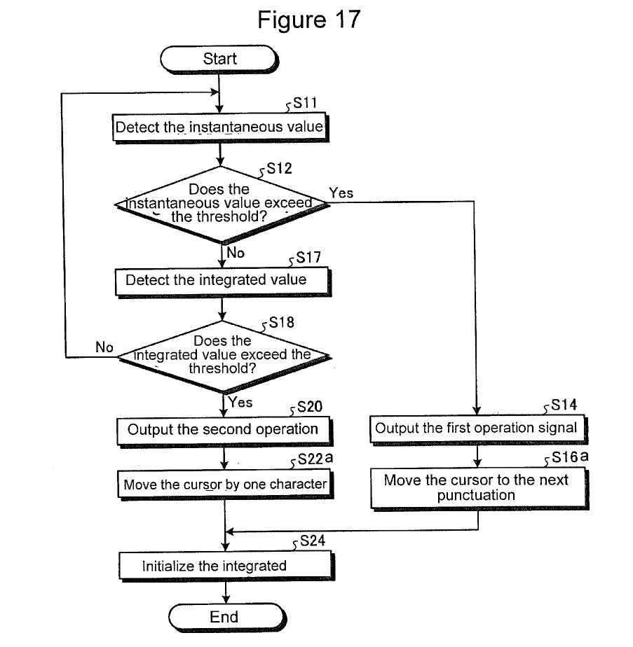

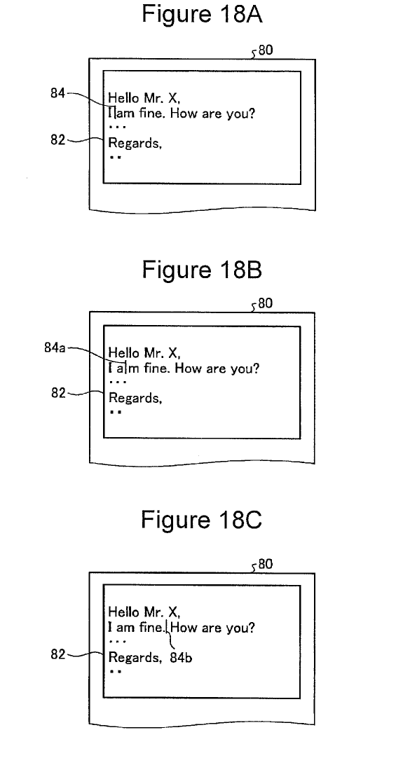

FIG. 17 is an illustration of an exemplary flow diagram of a mobile phone terminal 1 according to an embodiment of the present disclosure. FIGS. 18A-18C are exemplary diagrams showing actions of a mobile phone terminal 1 according to an embodiment of the present disclosure.

Each action of the mobile phone terminal 1 shown in FIG. 17 and FIG. 18A to FIG. 18C is processed by transmitting and receiving the information at both the processing module 36 of the input device 24 and the primary control module 10. The primary control module 10 processes the processing of the flow diagram shown in FIG. 17 and the detection processing of the character input operation, in parallel with each other. Specifically, while the processing that is input to the input device 24 as shown in FIG. 17 is being performed, if the character input operation is detected on the text edit screen of the touch panel 2, character input is performed based on the operation. FIG. 17 is different from FIG. 11 in terms of the processing details of task S16 and task S22. Below, aspects different from FIG. 11 are [symbol] explained.

First, the mobile phone terminal 1, as at task S11, detects the instantaneous value from the first detection module 52 of the input device 24. After the mobile phone terminal 1 detects the instantaneous value at task S11, as at task S12, it determines, from the signal generation module 58, whether the detected instantaneous value exceeds the threshold (threshold of the displacement amount), that is, it determines whether the threshold of the displacement amount is smaller than the instantaneous value.

If the mobile phone terminal 1 determines that the instantaneous value exceeds the threshold at task S12 (Yes at task S12), that is, if it determines that the threshold of the displacement amount is smaller than the instantaneous value, as at task S14, it generates the first operation signal at the signal generation module 58, and outputs the first operation signal to the primary control module 10.

Subsequently, the mobile phone terminal 1, as at task S16a, moves the cursor to the next punctuation, as instructed by the primary control module 10. Here, when the primary control module 10 receives the first operation signal, it extracts and decides the action with respect to the first operation signal from the condition table and performs the action that is decided upon. As is the case with the present embodiment, for cases in which the text edit screen is displayed, the action to move the cursor showing the position of the edit subject from the position currently shown in the text (character string) to the next punctuation is associated with the first operation signal. Therefore, when the primary control module 10 receives the first operation signal, it moves the position of the cursor to the next punctuation. The direction in which the cursor is moved is the direction corresponding to the displacement direction of the subject. After the mobile phone terminal 1 ends the processing at task S16a, it proceeds to task S24. If the mobile phone terminal 1 determines that the instantaneous value does not exceed the threshold at task S12 (No at task S12), the process proceeds task S17. As at task S22a, the mobile phone terminal 1 moves the cursor by one character.

After the mobile phone terminal 1 performs processing at task S16a or task S22a, as at task S24, it initializes the integrated value that is calculated at the second detection module 54 or set the integrated value “0” and subsequently ends the processing. While the state in which the text edit screen is displayed is continued, that is, while the application is being performed, the mobile phone terminal 1 repeatedly performs the above processing.

The text (character string) that is input is displayed and on the area 82, a cursor 84 is displayed. Here, on the area 82, the text, “Hello Mr. X, I am fine. How are you? . . . . Regards, . . . ”, is displayed, and the cursor 84 specifies before “am”. In this state, when characters are input, the input characters are inserted before “am”, and displayed accordingly.

The position of the cursor 84a is moved so as to reach the state in which the cursor 84a is placed between “a” and “m.”

When the moving direction detects the first operation signal rightwards from the left side of the screen, the position of the cursor 84b is moved so as to reach the state in which the cursor 84b is placed between “.” and “H.” The cursor is moved to the next punctuation from the position currently specified by the cursor.

As the cursor 84 increases the number of characters to move, the user can perform intuitive operations. Since it is no longer necessary to input multiple operations, the operation is possible in a short period of time; thereby, reducing the operation time.

As shown in the present embodiment, by using the input device 24 that detects the movement of the fingers, etc., as is the case with an optical mouse, the cursor can be moved without it being moved by the distance by which the user wants to move. That is, movement can be controlled on the spot.

Cases in which the threshold of the displacement amount is set with multiple values are explained below.

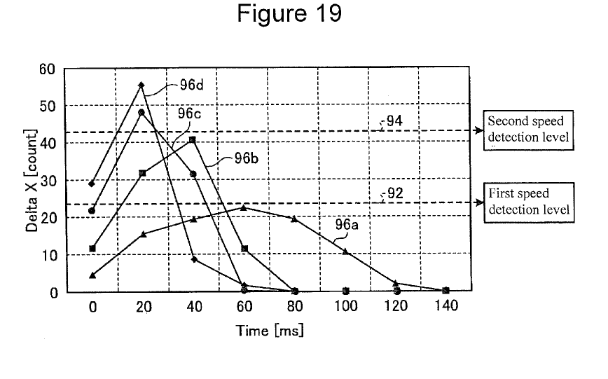

FIG. 19 is an illustration of an exemplary diagram showing an action of an input device according to an embodiment of the present disclosure. The vertical axis represents the displacement amount (ΔX) (count), and the horizontal axis represents the time (ms). The unit count of the displacement amount is the detection unit of the displacement amount with the input device (for example, the number of pixels moved).

First, for the mobile phone terminal 1, as the threshold of the displacement amount, a first speed detection level (first threshold) 92 and a second speed detection level (second threshold) 94 are provided. Here, the second threshold is set at a higher displacement amount than the first threshold. Even for cases of the present embodiment, as is the case with the above, the threshold with respect to the integrated value is also set. The relationship between the threshold of the integrated value and the threshold of the displacement amount is the same as above.

In this manner, by setting the first threshold 92, the second threshold 94, and threshold of the integrated value, the mobile phone terminal 1 can divide the detection pattern for detecting the inputs into three patterns, with the movement amount being more than a fixed amount (input exceeding the threshold of the integrated value). Specifically, the mobile phone terminal 1 can divide the detection pattern into cases in which the instantaneous value (the maximum value of the instantaneous value for the detection pattern) does not exceed the first threshold 92, as shown in a detection pattern 96a in FIG. 19, cases in which the instantaneous value exceeds the first threshold 92 and in which it does not exceed the second threshold 94, as shown in a detection pattern 96b, and cases in which the instantaneous value exceeds the second threshold 94, as shown in a detection pattern 96c and a detection pattern 96d. The mobile phone terminal 1 classifies the detection pattern into three patterns, based on the instantaneous value and the integrated value of the detected inputs, and controls according to the respective detection patterns. For the mobile phone terminal 1, for cases in which the instantaneous value does not exceed the first threshold 92 (that is, cases in which even if it exceeds the threshold of the integrated value, the instantaneous value does not exceed the first threshold 92), it outputs the second operation signal, and for cases in which the instantaneous value exceeds the first threshold 92 and, furthermore, in which it does not exceed the second threshold 94, it outputs a third operation signal, and for cases in which the instantaneous value exceeds the second threshold 94, it outputs the first operation signal. To each operation signal, varying operations are allocated respectively.

Next, the action for cases in which the mobile phone terminal 1 receives the operation to the input device 24 is explained.

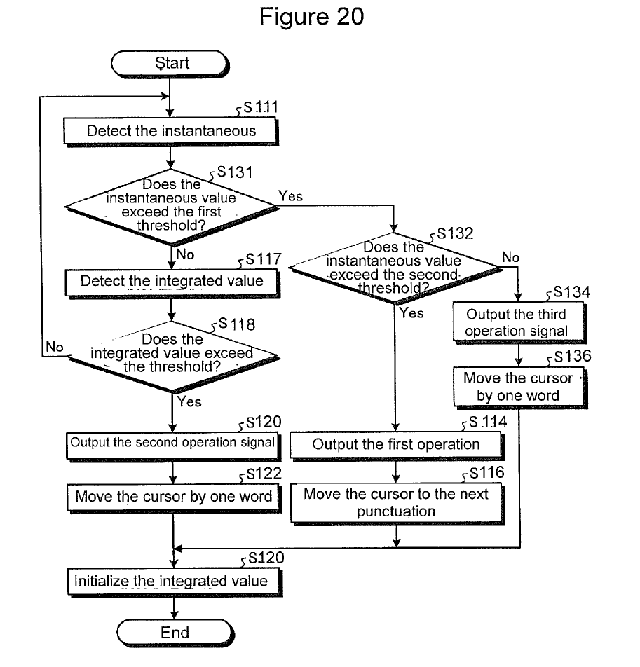

FIG. 20 is a flow diagram showing one example of actions of the mobile phone terminal. As at task S111, the mobile phone terminal 1 detects the instantaneous value from the first detection module 52 of the input device 24. When the mobile phone terminal 1 detects the instantaneous value at task S111, as at task S130, it determines whether the detected instantaneous value resulting from the signal generation module 58 exceeds the first threshold, that is, it determines whether the first threshold is smaller than the instantaneous value.

If the mobile phone terminal 1 determines at task S130 that the instantaneous value exceeds the first threshold (Yes at task S130), that is, if it determines that the first threshold of the displacement amount is smaller than the instantaneous value, as at task S132, it determines whether or not the detected instantaneous value resulting from the signal generation module 58 exceeds the second threshold, that is, it determines whether the second threshold is smaller than the instantaneous value. For the mobile phone terminal 1, with regard to determination at task S132, after the input of the detection pattern is completed, it compares the maximum value of the instantaneous value of the detection pattern.

If the mobile phone terminal 1 determines at S132 that the instantaneous value exceeds the second threshold (Yes at task S132), as at task S114, it generates the first operation signal at the signal generation module 58 and outputs the first operation signal to the primary control module 10. Subsequently, the mobile phone terminal 1, as at task S116, as instructed by the primary control module 10, moves the cursor to the next punctuation. After the mobile phone terminal 1 ends the processing at task S116, it proceeds to task S124.

If the mobile phone terminal 1 determines at task S132 that the instantaneous value does not exceed the second threshold (No at task S132), as at task S134, it generates the third operation signal at the signal generation module 58, and outputs the third operation signal to the primary control module 10. Subsequently, the mobile phone terminal 1, as at task S136, moves the cursor by one word, as a result of instructions from the primary control module 10. Here, when the primary control module 10 receives the third operation signal, it extracts and decides the action with respect to the third operation signal from the condition table and performs the action that is decided upon. As is the case with the present embodiment, for cases in which the text edit screen is displayed, the action to move the cursor showing the position of the edit subject from the position currently shown in the text (character string) to the next word (that is, for one word) is associated with the third operation signal. Based on this, if the primary control module 10 receives the third operation signal, it moves the position of the cursor by one word. The direction in which the cursor is moved is the direction corresponding to the displacement direction of the subject. After the mobile phone terminal 1 ends the processing at task S136, it proceeds to task S124.

If the mobile phone terminal 1 determines at task S130 that the instantaneous value does not exceed the first threshold (No at task S130), that is, if it determines that the threshold of the displacement amount is equal to or larger than the instantaneous value, as at task S117, it detects the integrated value from the second detection module 54. Since the processing from tasks S117, 118, S120 and S122 is the same as tasks S17, S18, S20 and S22 in the processing shown in FIG. 17, an explanation is omitted.

After the mobile phone terminal 1 performs processing at task S116, task S122, and task S136, as at task S124, it initializes the integrated value that is calculated at the second detection module 54 and subsequently ends the processing. While the state in which the text edit screen is displayed is continued, that is, while the application is being performed, the mobile phone terminal 1 repeatedly performs the above processing.

In this way, as the mobile phone terminal 1 sets the threshold of the instantaneous value with multiple items and as it associates the respective speed scope with the operation, more operations can be performed at the input device 24. The faster the input speed, the larger the movement of the cursor; thereby, allowing intuitive operations to be performed. As the threshold of the input speed, three stages, a stage with a speed of 10 (cm/s) or less, a stage with a speed faster than 10 (cm/s) and 30 (cm/s) or below, and a stage with a speed of 30 (cm/s) or more, can be mentioned. For cases in which the instantaneous value is 10 (cm/s) or less, as described above, the setting may be such that when the integrated value exceeds the threshold, it determines that the inputs be performed.

As shown in the above embodiment, it is preferable that for cases in which the operation in the same direction (parallel direction) as the display direction (array direction of characters) is input to the input device 24, the mobile phone terminal 1 performs the moving processing of the above cursor. Based on this, it is possible to move the cursor showing the text edit position along the character string. For cases of the present embodiment, the texts are written horizontally; however, the same applies for cases in which the texts are written vertically.

It is preferable that even for cases in which the operation in the direction perpendicular to the display direction (array direction of characters) of sentences constituting the text is input to the input device 24, similarly, the mobile phone terminal 1 sets the operation to be performed as a different operation, based on the instantaneous value and the integrated value. That is, with regard to cases in which the operation in the direction perpendicular to the display direction (array direction of characters) of sentences constituting the text is input, it is preferable that the threshold of the instantaneous value and the threshold of the integrated value be set, the detected instantaneous values and the integrated values, the threshold of the instantaneous values, and the threshold of the integrated values be compared, and based on the comparison results, the operation signal to be output (the first operation signal, the second operation signal, the third operation signal, etc.) be determined, and based on the operation signal, multiple operations may be performed. Based on this, while the text edit screen is being displayed, it is possible to easily input more operations.

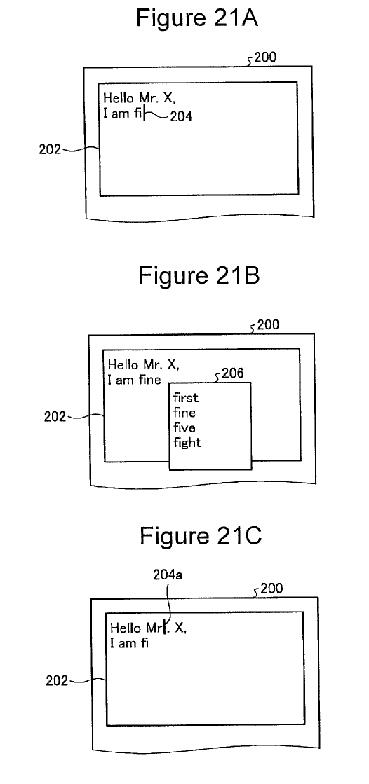

FIGS. 21A-21C are exemplary diagrams showing actions of a mobile phone terminal 1 according to an embodiment of the present disclosure. FIG. 21A to FIG. 21C represent one example of the processing for cases in which the operation in the direction perpendicular to the display direction of sentences constituting the texts (array direction of characters) is input. First, on the mobile phone terminal 1, as shown in FIG. 21A, the text that is input (character string) is displayed on an area 202 of a screen 200, and on an area 202, a cursor 204 is displayed. Here on the area 202, as a text, “Hello Mr. X, I am fi,” is displayed, and the cursor 204 specifies after “fi.” In this state, when the characters are input, the input characters are inserted and displayed after “fi.”

In the state of the screen shown in FIG. 21A, if the mobile phone terminal 1 detects the first operation signal with the moving direction in the upward direction of the screen, as shown in FIG. 21B, it displays a conversion character field 206. The conversion character field 206 is a field that detects a character string that is being input before and after where the cursor 204 specifies, and in the present embodiment, it detects and displays the conversion characters for “fi.” A search for the conversion characters can be performed using a dictionary function. Subsequently, after the conversion character is selected and the operation to be decided upon is input, the word that is decided upon is displayed on the area 202 as text.

In the state of the screen shown in FIG. 21A, if the mobile phone terminal 1 detects the second operation signal with the moving direction in the upward direction of the screen, as shown in FIG. 21C, it moves the position of a cursor 204a such that it reaches the state in which the cursor 204a specifies between “r” and “.”. That is, the cursor is moved to the corresponding position, which is the upper row of the position that the cursor currently specifies.

In this way, for the mobile phone terminal 1, with respect to the input to the input device 24, by allocating other functions, in addition to the movement of the cursor, the user can easily input more operations. In the present embodiment, with regard to the operation in the direction perpendicular to the display direction (array direction of characters) of sentences constituting the text, actions other than the movement actions of the cursor were associated; however, multiple movement actions of the cursor (for example, movement of one row, movement up to one paragraph above, etc.) may be associated. As an action other than the movement actions of the cursor, not only is the display of the estimated conversion characters performed, but also various operations for the text edit can be associated.

In the above embodiment, it was set such that the mobile phone terminal 1 comprises the touch panel; however, the present invention is not limited to this.

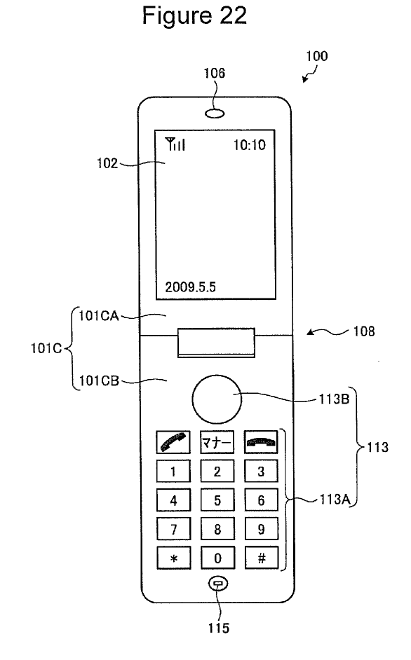

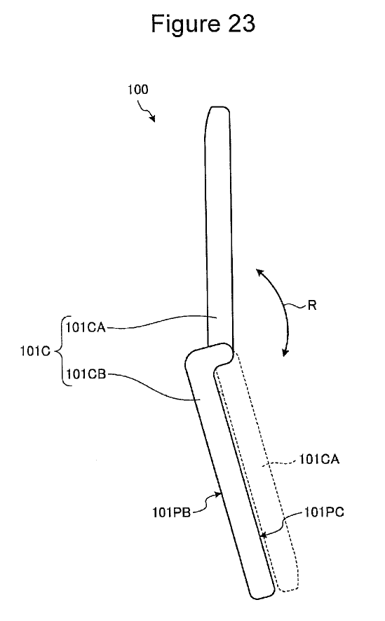

FIG. 22 is a front view showing a schematic configuration of another embodiment of the mobile phone terminal according to the embodiment. FIG. 23 is a side view of the mobile phone terminal shown in FIG. 22. The mobile phone terminal 100 shown in FIG. 22 and FIG. 23 is a mobile phone comprising a wireless communication function. For the mobile phone terminal 100, a housing 101C comprises multiple housings. Specifically, the housing 101C can be opened and closed with a first housing 101CA and a second housing 101CB. That is, the mobile phone terminal 100 comprises folding-type housings. The housings of the mobile phone terminal 100 are not limited to these types of configurations. For example, the housings of the mobile phone terminal 100 may be a sliding-type housing such that one housing and another housing are slid with respect to each other; a rotary-type housing in which around the shaft line along the overlapping direction, one housing is rotated; or a type in which both housings are connected through a 2-axis hinge. The first housing 101CA and the second housing 101CB are connected with a hinge mechanism 108, which is a connecting part. By connecting the first housing 101CA and the second housing 101CB with the hinge mechanism 108, the first housing 101CA and the second housing 101CB can be rotated relatively in the direction shown by the arrow R in FIG. 23, around the hinge mechanism 108. The first housing 101CA and the second housing 101CB can be moved from the position shown by the solid line in FIG. 23 to the position shown by the dotted line in FIG. 23, around the hinge mechanism 108, specifically to the position in the state in which it is folded.

As the display module, a display 102 (2 in FIG. 1) is provided on the first housing 101CA. While the mobile phone terminal 1 is in a state in which it awaits reception, the display 102 displays an idle image, or it displays a menu image used for supplementing the operation of the mobile phone terminal 100. A receiver 106, which is an output means for outputting sound during a call using the mobile phone terminal 100, is provided on the first housing 101CA.

Multiple operation keys 113A for inputting telephone numbers of the intended party or for inputting characters while composing e-mails, etc., are provided on the second housing 101CB, and an input device 113B is provided on the hinge 108 side of the operation keys 113A. The operation keys 113A and the input device 113B constitute an operation module 113 of the mobile phone terminal 100. A microphone 115, which is a sound obtaining means for receiving sound during a call using the mobile phone terminal 100, is provided on the second housing 101CB. The operation module 113 is provided on an operation surface 101PC of the second housing 101CB. The surface on the opposite side from the operation surface 101PC is a rear surface 101PB of the mobile phone terminal 100.

An antenna is provided inside the second housing 101CB. The antenna is a transmitting and receiving antenna used for wireless communications and is used for transmitting and receiving the electric waves (electromagnetic waves) related to telephone calls, e-mails, etc., between the mobile phone terminal 100 and the base station. A microphone 115 is provided on the second housing 101CB. The microphone 115 is disposed on the operation surface 101PC side of the mobile phone terminal 100.

As is the case with the mobile phone terminal 100, even for cases in which it comprises the operation keys 113A, by providing the input device 113B, the various operations above can be input. That is, the input device 113B can be used as the direction and decision key for selecting and deciding the menu to be displayed on the display 102 and for easily performing screen scrolling, etc.

In the above embodiment, control was performed based on whether or not the instantaneous value and the integrated value exceed the integrated values that are set with respect to the respective values; however, the present invention is not limited to this. The mobile phone terminal (electronic devices) may determine the operation input based on both the detected instantaneous value and integrated value, and the operation can be determined using various criteria. In the above embodiment, the operation signals were generated with the input device; however, it may be constituted such that the input device detects only the instantaneous value and the integrated value, and such that it generates the operation signals at the primary control module.

The abovementioned input module (input device and the control thereof) can be used for various electronic devices, as mentioned above; however, as described above, it is preferably used for the mobile electronic devices, and specifically for the mobile phone terminal. Even for cases in which the devices are made so as to be small and thin, such as with mobile phone devices, specifically for the mobile phone terminal, and in which the area for the input module that can be disposed is small, various inputs are possible with one input device. As a result, the effect of the present invention can be more appropriately obtained.

In the present embodiment, the second detection module was provided; however, it is not necessary to use the integrated value of the instantaneous value. In the above embodiment, the first detection module, the second detection, and the timer module are the parameter detection modules

As above, the electronic device according to the present embodiment is effective for inputting operations, and is specifically suitable for cases in which it is necessary to move the cursor and the pointer.

Terms and phrases used in this document, and variations hereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future.

Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the present disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The term “about” when referring to a numerical value or range is intended to encompass values resulting from experimental error that can occur when taking measurements.

1. An electronic device comprising:
a housing;
a displacement detection module comprising a detection surface that is disposed in the housing, and operable to detect a displacement of a substance that is brought into contact with the detection surface;
a detection module operable to:
detect an instantaneous value of the displacement; and
detect an integrated value of the displacement;
a signal generation module operable to generate a control signal based on the instantaneous value and the integrated value; and
a control module operable to perform a predefined function in response to the control signal.

2. The electronic device according to claim 1, wherein the detection module comprises:
a first detection module operable to detect the instantaneous value of the displacement; and
a second detection module operable to detect the integrated value of the displacement and initialize the integrated value when the second detection module outputs the control signal.

3. The electronic device according to claim 1, wherein
if the instantaneous value exceeds a displacement threshold, the control signal comprises a first control signal, and if the instantaneous value is equal to or less than the displacement threshold and if the integrated value exceeds an integration threshold, the control signal comprises a second control signal and an action of the predefined function is set so as to vary between the first control signal and the second control signal.

4. The electronic device according to claim 1, wherein the displacement detection module is further operable to:
continuously capture images of the substance that is brought into contact with the detection surface, process the images, and
detect the displacement based on a displacement of characteristics of the substance.

5. The electronic device according to claim 1, further comprising a display module located on the housing, wherein
when multiple items that can be selected with a cursor are disposed in a row on the display module based on a display rule and a screen in which one of the items is specified by the cursor is displayed, the control module is operable to:
change a fixed number of items in a list that causes the items to be displayed on the display module based on the display rule if a first control signal is input; and
switch an item specified by the cursor to an adjacent item if a second control signal is input.

6. The electronic device according to claim 1, further comprising a moving direction detection module operable to detect a move direction of the substance based on differences in a subject that is detected in the displacement detection module, wherein
the control module is operable to perform the predefined function based on the move direction that is detected in the moving direction detection module.

7. The electronic device according to claim 1, wherein the control module is further operable to:
set a displacement threshold using a multiple displacement amount; and
switch one or more control signals generated in response to the detected instantaneous value.

8. An electronic device, comprising:
a housing;
a display module on the housing;
a displacement detection module comprising a detection surface that is disposed in the housing, and operable to detect a substance displacement of a substance that is brought into contact with the detection surface;
a detection module operable to detect:
an instantaneous value of the substance displacement; and
a time interval in which the substance displacement is measured; and
a control module operable to:
generate a control signal based on the instantaneous value and the time interval if the instantaneous value exceeds a displacement threshold of the displacement;
control the predefined function based on the control signal; and
change the threshold of the substance displacement based on the time interval.

9. The electronic device according to claim 8, wherein:
the detection module comprises:
a first detection module operable to detect the instantaneous value of the substance displacement;
a second detection module operable to detect an integrated value of the substance displacement; and
a timer module operable to measure an elapsed time from a completion of a measurement of an input that generated either one of a first control signal or a second control signal, as a time interval; and
the control module generates the first control signal if the instantaneous value exceeds the displacement threshold;
the control module generates the second control signal if the instantaneous value is equal to or less than the displacement threshold and if the integrated value exceeds an integration threshold; and
the control module executes varying controls between the first control signal and the second control signal that are input from a signal generation module, and controls an image to be displayed on the display module.

10. The electronic device according to claim 9, wherein the control module is further operable to set the threshold of the substance displacement based on whether the elapsed time and the control signal generated immediately prior are the first control signal or the second control signal.

11. The electronic device according to claim 9, wherein the control module is further operable to set the displacement threshold higher if the control signal generated immediately prior is the second control signal.

12. The electronic device according to claim 8, wherein, when an image larger than a display area of a screen is displayed on the display module, the control module is further operable to:
display an image, which has displayed in a first area on the display module, in a second area adjacent to the first area if a first control signal is input, and
display an image, which has displayed in a first area on the display module, in a third area away from the first area by a predefined distance if a second control signal is input.

13. The electronic device according to claim 8, wherein, if a second control signal is input when the display module displays an image larger than a display area of a screen thereon, the control module is further operable to:
calculate an amount of movement based on an integrated value; and
display the image, which has displayed in a first area on the display module, in a fourth area away from the first area by the amount of movement if the second control signal is input.

14. The electronic device according to claim 8, wherein the control module, even for cases in which varying controls are performed between a first control signal and a second control signal that are input; an image to be displayed on the display module is controlled; and a same control signal is continuously generated for more than a fixed times, it is determined that either the instantaneous value exceeds the displacement threshold, or an integrated value of a displacement amount exceeds an integration threshold, the same control signal as immediately prior is generated.

15. The electronic device according to claim 8, further comprising a text editing function, wherein, while a screen for text edit is being displayed, based on one or more control signals input from the control module, on a character edit screen, an amount of movement of a cursor showing a position of the edit subject is determined, the cursor is moved based on the amount of movement determined, and at a same time, when a first control signal is input, the amount of movement of the cursor is made so as to be larger, compared to cases in which a second control signal is input.

16. The electronic device according to claim 8, wherein the control module, when a second control signal is input, moves a cursor by one character, and when a first control signal is input, it moves the cursor by a larger extent than by one character.

17. The electronic device according to claim 8, wherein the control module, for the displacement threshold, sets a first displacement threshold and a second displacement threshold, which is a larger value than the first displacement threshold, and for cases in which it exceeds the second displacement threshold, it generates a first control signal, and for cases in which the instantaneous value exceeds the first displacement threshold and in which it is equal to or less than the second displacement threshold, a third control signal is generated, and the control module, when the third control signal is input, moves a cursor by one character, and when the first control signal is input, moves the cursor to a subsequent punctuation.

18. The electronic device according to claim 8, further comprising a moving direction detection module that detects the moving direction of a subject, based on the substance displacement detected in the displacement detection module, wherein the control module, for cases in which the moving direction detected in the moving direction detection module is parallel to a direction of a character string, moves a cursor.

19. The electronic device according to claim 8, wherein for the control module, when a second signal, which is in a move direction in which the move direction detected in a moving direction detection module is perpendicular to a direction of a character string, is input, it moves a cursor to an adjacent character string, and when a first control signal, which is in the move direction in which the move direction detected in the move direction detection module is perpendicular to the direction of the character string, is input, it displays one or more prediction conversion characters of the character string that the cursor shows.

20. A method for operating an input device, the method comprising:
detecting a displacement of a substance that is brought into contact with a detection surface;
detecting an instantaneous value of the displacement;
detecting an integrated value of the displacement;
generating a control signal based on the instantaneous value and the integrated value; and
performing a predefined function in response to the control signal.
